(19) United States
(12) Patent Application Publication
(10) Pub. No.: US 2011/0244745 A1
(43) Pub. Date: Oct. 6, 2011

(54) ELECTROSTATIC CHARGE DISSIPATIVE MATERIALS BY VACUUM DEPOSITION OF POLYMERS

(75) Inventors: Benyoussef Bisbis, Echternach (LU); Ioannis V. Bletsos, Midlothian, VA (US); Noel Stephen Brabbs, Garnich (LU)

(73) Assignee: E.I. DU PONT DE NEMOURS AND COMPANY, Wilmington, DE (US)

(21) Appl. No.: 12/884,322

(22) Filed: Sep. 17, 2010

Related U.S. Application Data
(60) Provisional application No. 61/246,221, filed on Sep. 28, 2009.

(51) Int. Cl. B32B 5/02; H05H 1/24; B32B 5/00; A41D 1/00

(52) U.S. Cl. 442/110; 427/569; 428/336; 2/69

(57) ABSTRACT

The present invention relates to a process for making electrostatic charge dissipative material comprising the following steps: (a) optionally pretreating a substrate in a plasma field; (b) flash evaporating at least one monomer and at least one hygroscopic additive into a vacuum chamber to produce a vapor; (c) condensing the vapor on the substrate to produce a film of the monomer and the hygroscopic additive coating on the substrate; and (d) curing the monomer of the film to produce a polymeric layer containing hygroscopic additive on the substrate; wherein the condensing step is carried out under vapor-density and residence-time conditions that limit the polymeric layer to a maximum thickness of about 3.0 μm. The electrostatic charge dissipative material can be used to protect electrostatic sensitive electronic components.

### FIELD OF THE INVENTION

The present invention relates to electrostatic charge dissipative materials that can be used to protect electrostatic sensitive electronic components or equipment.

### BACKGROUND

Electronic components or equipment can be sensitive to electrostatic discharge. Care must be exercised when assembling, handling or operating electronic components or equipment in order to avoid the accidental electrostatic discharge which could potentially damage the electronic components or equipment. For example, under certain conditions, the human body can generate and hold electrostatic charge. Electrostatic charge dissipative materials can be used between the human body and the electronic components or equipment to prevent or reduce the electrostatic generation and thereby preventing or reducing electrostatic discharge to electronic components or equipment. Electrostatic charge dissipative materials can include apparel for individuals working with electronic components or equipment as well as packaging such as materials for wrapping or separating electronic components or equipment for protecting the electronic components or equipment itself. Also, under certain conditions, equipment and materials can develop an electrostatic charge without interaction with the human body. For example, electronic components such as silicon wafers are stacked and stored with sheets used to separate the wafers. These sheets need to help reduce the buildup of an electrostatic charge to protect the wafers.

In addition to protecting electronic components or equipment from electrostatic discharge, these same electrostatic charge dissipative materials can sometimes be damaged due to contamination. Particles, ions or gasses introduced to controlled environments like clean rooms can create problems for contamination sensitive products.

It would be desirable to provide electrostatic charge dissipative materials that can be used to protect sensitive electronic components or equipment while reducing the chance for particulate, ionic and/or gaseous contamination.

### SUMMARY OF THE INVENTION

The present invention relates to a process for making electrostatic charge dissipative material comprising the following steps: (a) optionally pretreating a substrate in a plasma field; (b) flash evaporating at least one monomer and at least one hygroscopic additive into a vacuum chamber to produce a vapor; (c) condensing the vapor on the substrate to produce a film of the monomer and the hygroscopic additive coating on the substrate; and (d) curing the monomer of the film to produce a polymeric layer containing hygroscopic additive on the substrate; wherein the condensing step is carried out under vapor-density and residence-time conditions that limit the polymeric layer to a maximum thickness of about 3.0 μm. The electrostatic charge dissipative material can be used in electronic component separators, articles of clothing such as garments, gloves, shoe covers and masks, electrostatic wipes and cleaning articles, electronic coverings or housings, and packaging materials.

### DETAILED DESCRIPTION OF THE INVENTION

The present invention relates to an electrostatic charge dissipative material made by a process of vacuum deposition of polymers and hygroscopic additives. This process not only makes the material electrostatic charge dissipative but limits the amount of particulate, ionic or gaseous contamination.

The term “electrostatic charge dissipative” as used herein refers to a material that has surface resistivity between 10⁶ to 10¹² Ohms/sq.

The term “hygroscopic additive” as used herein refers to a material that absorbs and retains moisture.

For a general description of plasma coating process see U.S. Pat. No. 7,157,117 incorporated herein by reference.

In its preferred embodiment, the invention is practiced by first optionally pretreating the substrate in a plasma field and then immediately subjecting it to the deposition of a thin layer of at least one vaporized monomer containing at least one hydroscopic additive in a vacuum deposition process. The monomer film is subsequently polymerized by exposing it to an electron-beam field or other radiation-curing process. The monomer is flash-evaporated and condensed on the substrate in a conventional manner trapping the hygroscopic additive on the substrate. The residence time of the substrate within the deposition zone of the vacuum chamber is controlled to ensure that a very thin film is deposited. This is achieved by controlling the vapor density and the speed of the moving substrate to limit the thickness of the coating to about 0.02 to 3 μm.

The substrate can be synthetic or natural materials including polypropylene fibers, polyethylene fibers, polyester fibers, polyamide fibers, polyaramide fibers, rayon fibers, glass fibers, carbon fibers, cellulose-based fibers, paper, cotton, wool, and films. The substrate is typically provided in the form of a nonwoven or woven fabric or sheet.

The monomer is selected from acrylic, methacrylic and vinyl monomers.

The hygroscopic additive is salt free and has a functional group of a hydroxyl, carboxyl, sulfonic, phosphonic, amino, amido, guanidino, alkyl or aryl hydrogen phosphate, alkyl or aryl hydrogen sulfate, ether and imine. The hygroscopic additive comprises between 1 to 50% by weight of the combined hygroscopic additive/polymeric layer.

The electrostatic charge dissipative material of the present invention has useful electronic properties as measured by surface resistivity and electrostatic decay time. The surface resistivity of the electrostatic charge dissipative material is between about 10⁶ to about 10¹² Ohms/square. The electrostatic decay time of the electrostatic charge dissipative material when subjected to a voltage of +5 or −5 kV is less than about 2 seconds. These electronic properties limit the buildup of electrostatic charge in order to protect sensitive electronic equipment and components.

In addition, the electrostatic charge dissipative material of the present invention has useful contamination prevention properties as measured by particle loss, inorganic aqueous ion loss, and gas loss. The particle loss of the electrostatic charge dissipative material is less than about 2,000 for particles between 0.5 to 1 μm in diameter, less than about 1,000 for particles between 1 to 3 μm in diameter, and less than about 200 for particles between 3 to 5 μm in diameter per m² of material. The inorganic aqueous ion loss of the electrostatic charge dissipative material is less than about 50 μg/g. The gas loss of the electrostatic charge dissipative material is less than about 200 μg/g. These contamination prevention properties limit the buildup of contaminants for clean room environments.

The electrostatic charge dissipative material of the present invention can be used as an electronic component separator, an article of clothing including garments, gloves, shoe covers and mask, an electrostatic wipe or cleaning article, an electronic covering or housing, and a packaging material.

### TEST METHODS

In the non-limiting examples that follow, the following test methods were employed to determine various reported characteristics and properties. ASTM refers to the American Society of Testing Materials. MIL refers to the United States military standard methods.

Surface Resistivity was measured according to ASTM D-257. Samples were conditioned in a controlled environment at 15% relative humidity and 23° C. for 24 hours. Results were reported in ohms/square.

Electrostatic Decay Time was measured according to MIL-B-81705C. Samples were conditioned in a controlled environment at 15% relative humidity and 23° C. for 24 hours. Both +5 kV and −5 kV voltages were applied and decay times measured until 10% of starting voltage was reached. Decay times were reported in seconds.

Particle Loss was measured using a liquid particle counter to determine the size and frequency distribution of particles. Isopropyl alcohol was used as the extracting medium. A laser is used to categorize particles. Results are reported in number of particles lost for a range of particle diameter sizes per 100 square inches of material and normalized to number of particles/m².

Inorganic Aqueous Ion Loss was measured using ion chromatography. The samples were extracted in deionized water at 60° C. for 20 minutes followed by ion chromatography. The total ion loss was reported in μg/g.

Gas Loss was measured using thermal desorption followed by gas chromatography/mass spectrometry. The samples were exposed to 65° C. for 20 minutes prior to analysis. The total gas loss was reported in μg/g.

### EXAMPLES

Several commercially available fabric samples were treated with hygroscopic additives according to the vacuum deposition process of the invention. Various electrostatic charge dissipation and contamination data were measured and the results were listed in the Table.

### Comparative Example A

Comparative Example A was a substrate of a high density polyethylene plexifilamentary film-fibril nonwoven sheet of Tyvek® 1073B (available from the DuPont Co., Wilmington, Del.). It was measured as received for various electrostatic charge dissipation and contamination data and the results were listed in the Table. Comparative Example A had poor (high) electrostatic charge dissipation properties.

### Comparative Example B

Comparative Example B used the same substrate as in Comparative Example A. In addition, Comparative Example B was plasma treated. The plasma treatment comprised exposure of the substrate to an 80% argon/20% oxygen plasma of 0.125 W/m in vacuum. Subsequently it was coated on one side with a monomeric acrylate-based formulation of beta-carboxyethyl acrylate (BCEA available from Polysciences, Inc., Warrington, Pa.)/bis(2-methacryloxyethyl)phosphate (bis-HEMA phosphate) (available from Polysciences, Inc., Warrington, Pa.)/trifunctional acid ester acrylate (CD9051 available from Sartomer Co, Exton, Pa.) in a ratio of 50/40/10 by weight. The formulation did not contain a hygroscopic additive. The coating was polymerized with an electron beam at 10 kV and 100-500 mA. All three steps of plasma treatment, coating and curing, were performed as a single pass in vacuum of 3.1×10⁻⁵ to 1.3×10⁻³ kPa. The same process was repeated on the other side of the substrate. The process speed was adjusted in combination with the monomer feed rate to give a desired coating weight as shown in the Table. Samples were obtained and various electrostatic charge dissipation and contamination data were measured and the results were listed in the Table. Comparative Example B had poor (high) electrostatic charge dissipation properties and good (low) contamination properties.

### Comparative Example C

Comparative Example C was Carbon Separator eIL8-200-0.13-X, a carbon black filled polyethylene film wafer separator, (available from Netmotion, Fremont, Calif.) was measured as received for various electrostatic charge dissipation and contamination data and the results were listed in the Table. Comparative Example C had good (low) electrostatic charge dissipation properties and poor (high) contamination properties.

### Example 1

Example 1 used the same substrate and underwent the same plasma, coating and curing steps as in Comparative Example B except a different coating which included a hydroscopic additive was used. The coating was BCEA/dodecylbenzene sulfonic acid (DBSA hygroscopic additive available from Sigma-Aldrich, St. Louis, Mo.)/CD9051 in a ratio of 58/28/14 by weight. Samples were obtained and various electrostatic and contamination data were measured and the results were listed in the Table. Example 1 had good (low) electrostatic charge dissipation properties and good (low) contamination properties as compared to Comparative Example C.

### Example 2

Example 2 used the same substrate and underwent the same plasma, coating and curing steps as in Example 1 except twice the amount of coating was applied. Samples were obtained and various electrostatic and contamination data were measured and the results were listed in the Table. Example 2 had good (low) electrostatic charge dissipation properties and good (low) contamination properties as compared to Comparative Example C.

### Example 3

Example 3 used the same used the same substrate and underwent the same plasma, coating and curing steps as in Example 1 except an 80% argon/20% nitrogen plasma at 0.9 W/m and a different coating were used. The coating was 1,6 hexanediol diacrylate (SR238 available from Sartomer Co., Exton, Pa.)/DBSA/lauryl acrylate (SR335 available form Sartomer Co., Exton, Pa.) in a ratio of 40/20/40 by weight. Samples were obtained and various electrostatic and contamination data were measured and the results were listed in the Table. Example 3 had good (low) electrostatic charge dissipation properties and good (low) contamination properties as compared to Comparative Example C.

The Examples of the invention provide good (low) electrostatic charge dissipation properties and good (low) contamination properties making them suitable for use with electrostatic sensitive electronic components or equipment and very low contamination end-use applications.

TABLE

| | | | | | | | Inorganic | |
|---|---|---|---|---|---|---|---|---|
| | | | | Coating | Surface | Electrostatic | Aqueous | Gas |
| | | Polymer | Hygroscopic | Weight | Resistivity | Decay Time | Ion Loss | Loss |
| Example | Plasma | Coating | Additive | (g/m²) | (Ohms/sq) | (s) | (μg/g) | (μg/g) |
| A | None | No | No | None | >10¹⁵ | >2 | | |
| B | Ar/O₂ | Yes | No | 0.69 | 4 × 10¹⁵ | 40 | | |
| C | | | | | 6.3 × 10⁹ | 0.03 | 231 | 400 |
| 1 | Ar/O₂ | Yes | Yes | 0.70 | 1.0 × 10⁹ | 0.04 | 12 | 130 |
| 2 | Ar/O₂ | Yes | Yes | 1.40 | 1.0 × 10⁹ | 0.03 | 35 | 120 |
| 3 | Ar/N₂ | Yes | Yes | 1.00 | 4.0 × 10¹¹ | 0.05 | 40 | 140 |

What is claimed is:

1. A process for making electrostatic charge dissipative material comprising the following steps:
(a) optionally pretreating a substrate in a plasma field;
(b) flash evaporating at least one monomer and at least one hygroscopic additive into a vacuum chamber to produce a vapor;
(c) condensing the vapor on the substrate to produce a film of the monomer and the hygroscopic additive coating on the substrate; and
(d) curing the monomer of the film to produce a polymeric layer containing hygroscopic additive on the substrate;
wherein the condensing step is carried out under vapor-density and residence-time conditions that limit the polymeric layer to a maximum thickness of about 3.0 μm.

2. The process of claim 1, wherein the substrate comprises a material selected from the group consisting of polypropylene fibers, polyethylene fibers, polyester fibers, polyamide fibers, polyaramide fibers, rayon fibers, glass fibers, carbon fibers, cellulose-based fibers, paper, cotton, wool, and films.

3. The process of claim 1, wherein the monomer is selected from the group consisting of acrylic, methacrylic and vinyl monomers.

4. The process of claim 1, wherein the hygroscopic additive is salt free and comprises a functional group selected from the group consisting of hydroxyl, carboxyl, sulfonic, phosphonic, amino, amido, guanidino, alkyl or aryl hydrogen phosphate, alkyl or aryl hydrogen sulfate, ether and imine.

5. The process of claim 1, wherein the material has a surface resistivity between about 10⁶ to about 10¹² Ohms/square.

6. The process of claim 1, wherein the material has an electrostatic decay time of less than about 2 s.

7. The process of claim 1, wherein the material has a particle loss of less than about 2,000 for particles between 0.5 to 1 μm in diameter, less than about 1,000 for particles between 1 to 3 μm in diameter, and less than about 200 for particles between 3 to 5 μm in diameter per m² of material.

8. The process of claim 1, wherein the material has a total inorganic aqueous ion loss of less than about 50 μg/g.

9. The process of claim 1, wherein the material has a total gas loss of less than about 200 μg/g.

10. An electrostatic charge dissipative material produced by the process of claim 1.

11. The material of claim 10, wherein the substrate comprises a material selected from the group consisting of polypropylene fibers, polyethylene fibers, polyester fibers, polyamide fibers, polyaramide fibers, rayon fibers, glass fibers, carbon fibers, cellulose-based fibers, paper, cotton, wool, and films.

12. The material of claim 10, wherein the monomer is selected from the group consisting of acrylic, methacrylic and vinyl monomers.

13. The material of claim 10, wherein the hygroscopic additive is salt free and comprises a functional group selected from the group consisting of hydroxyl, carboxyl, sulfonic, phosphonic, amino, amido, guanidino, alkyl or aryl hydrogen phosphate, alkyl or aryl hydrogen sulfate, ether and imine.

14. The material of claim 10, wherein the material has a surface resistivity between about 10⁶ to about 10¹² Ohms/square.

15. The material of claim 10, wherein the material has an electrostatic decay time of less than about 2 s.

16. The material of claim 10, wherein the material has a particle loss of less than about 2,000 for particles between 0.5 to 1 μm in diameter, less than about 1,000 for particles between 1 to 3 μm in diameter, and less than about 200 for particles between 3 to 5 μm in diameter per m² of material.

17. The material of claim 10, wherein the material has a total inorganic aqueous ion loss of less than about 50 μg/g.

18. The material of claim 10, wherein the material has a total gas loss of less than about 200 μg/g.

19. An electrostatic charge dissipative material comprising a substrate coated with a polymeric layer containing a hygroscopic additive to a maximum thickness of about 3.0 μm.

20. The material of claim 19, wherein the substrate comprises a material selected from the group consisting of polypropylene fibers, polyethylene fibers, polyester fibers, polyamide fibers, polyaramide fibers, rayon fibers, glass fibers, carbon fibers, cellulose-based fibers, paper, cotton, wool, and films.

21. The material of claim 19, wherein the monomer is selected from the group consisting of acrylic, methacrylic and vinyl monomers.

22. The material of claim 19, wherein the hygroscopic additive is salt free and comprises a functional group selected from the group consisting of hydroxyl, carboxyl, sulfonic, phosphonic, amino, amido, guanidino, alkyl or aryl hydrogen phosphate, alkyl or aryl hydrogen sulfate, ether and imine.

23. The material of claim 19, wherein the material has a surface resistivity between about 10⁶ to about 10¹² Ohms/square.

24. The material of claim 19, wherein the material has an electrostatic decay time of less than about 2 s.

25. The material of claim 19, wherein the material has a particle loss of less than about 2,000 for particles between 0.5 to 1 μm in diameter, less than about 1,000 for particles between 1 to 3 μm in diameter, and less than about 200 for particles between 3 to 5 μm in diameter per m² of material.

26. The material of claim 19, wherein the material has a total inorganic aqueous ion loss of less than about 50 μg/g.

27. The material of claim 19, wherein the material has a total gas loss of less than about 200 μg/g.

28. An electronic component separator comprising a substrate coated with a polymeric layer containing a hygroscopic additive to a maximum thickness of about 3.0 μm.

29. An article of clothing comprising a substrate coated with a polymeric layer containing a hygroscopic additive to a maximum thickness of about 3.0 μm.

30. The article of clothing of claim 29, wherein the article of clothing comprises garments, gloves, shoe covers and masks.

31. A packaging material comprising a substrate coated with a polymeric layer containing a hygroscopic additive to a maximum thickness of about 3.0 μm.

32. An electrostatic charge dissipative wipe comprising a substrate coated with a polymeric layer containing a hygroscopic additive to a maximum thickness of about 3.0 μm.

33. An electrostatic charge dissipative covering comprising a substrate coated with a polymeric layer containing a hygroscopic additive to a maximum thickness of about 3.0 μm.
